(19) United States
(12) Patent Application Publication
(10) Pub. No.: US 2018/0208833 A1
(43) Pub. Date: Jul. 26, 2018

(54) LOW-POLYMER LOADING TREATMENT FLUID FOR USE IN SUBTERRANEAN FORMATION OPERATIONS

(71) Applicant: Halliburton Energy Services, Inc., Houston, TX (US)

(72) Inventors: Prashant CHOPADE, Kingwood, TX (US); Jeremy HOLTSCLAW, Kingwood, TX (US); Edith SCOTT, Humble, TX (US); Gladys Rocio MONTENEGRO GALINDO, Kingwood, TX (US)

(21) Appl. No.: 15/745,983

(22) PCT Filed: Sep. 16, 2015
(86) PCT No.: PCT/US15/50455

§ 371 Date: Jan. 18, 2018

(51) Int. Cl. C09K 8/88; C09K 8/68; C09K 8/44; E21B 43/04; E21B 43/26; E21B 43/267

(52) U.S. Cl. CPC C09K 8/887; C09K 8/685; E21B 43/267; E21B 43/04; E21B 43/26; C09K 8/44

(57) ABSTRACT

Methods including introducing a low-polymer loading treatment fluid (LPLTF) into a subterranean formation for performing a subterranean formation operation at a target interval. The LPLTF comprises an aqueous-based fluid, a guar-based gelling agent in an amount of less than about 2.4 grams/liter of the liquid portion of the LPLTF, and a dual crosslinking additive comprising a metal crosslinker and a multifunctional boronic acid crosslinker in a ratio in the range of about 1:100 to about 100:1.

### BACKGROUND

The present disclosure relates to subterranean formation operations and, more particularly, to low-polymer loading treatment fluids for use in subterranean formation operations.

Hydrocarbon producing wells (e.g., oil producing wells, gas producing wells, and the like) are often stimulated by hydraulic fracturing treatments. In traditional hydraulic fracturing treatments, a treatment fluid, sometimes called a carrier fluid in cases where the treatment fluid carries particulates entrained therein, is pumped into a portion of a subterranean formation (which may also be referred to herein simply as a “formation”) above a fracture gradient sufficient to break down the formation and create one or more fractures therein. The general term “treatment fluid,” as used herein, refers generally to any fluid that may be used in a subterranean application in conjunction with a desired function and/or for a desired purpose. The term “treatment fluid” does not imply any particular action by the fluid or any component thereof. As used herein, the term “fracture gradient” refers to a pressure (e.g., flow rate) necessary to create or enhance at least one fracture in a subterranean formation.

Typically, particulate solids are suspended in a portion of one or more treatment fluids and then deposited into the fractures. The particulate solids, known as “proppant particulates” or simply “proppant” serve to prevent the fractures from fully closing once the hydraulic pressure is removed. By keeping the fractures from fully closing, the proppant particulates form a proppant pack having interstitial spaces that act as conductive paths through which fluids produced from the formation may flow. As used herein, the term “proppant pack” refers to a collection of proppant particulates in a fracture, thereby forming a “propped fracture.”

Certain subterranean formations may have weakly consolidated intervals that contain loose particles having insufficient bond strength to withstand the forces created by fluids flowing through the formation during subterranean formation operations. One approach designed to prevent the movement of loose particles in a wellbore in a subterranean formation (or to “stabilize” or “consolidate”) is the use of gravel packing or frac-packing techniques.

“Gravel packing” is a particulate control method in which a permeable screen is placed in a wellbore and the annulus between the screen and the formation surface is packed with gravel of a specific size designed to prevent the passage of loose particles from flowing through the gravel packed screen, referred to as a “gravel pack.” “Frac-packing” is a combined hydraulic fracturing and gravel packing treatment. In frac-packing operations, a substantially particulate-free fluid is generally pumped through the annulus between a permeable screen and a wellbore at a rate and pressure sufficient to create or enhance at least one fracture. Thereafter, a treatment fluid comprising particulates is pumped through the annulus and the particulates are placed within the at least one fracture and in the annulus between the permeable screen and the wellbore, forming both a “proppant pack” in the fracture and a “gravel pack” in the annulus. In some embodiments, the treatment fluid comprising the particulates may be pumped at a rate and pressure sufficient to enhance the at least one fracture already formed.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 shows an illustrative schematic of a system that can deliver LPLTFs of the present disclosure to a downhole location, according to one or more embodiments of the present disclosure.

FIG. 2 shows a graph depicting the viscosity of treatment fluids, including several LPLTFs prepared according to one or more embodiments of the present disclosure.

### DETAILED DESCRIPTION

The present disclosure relates to subterranean formation operations and, more particularly, to low-polymer loading treatment fluids for use in subterranean formation operations.

The present disclosure describes the use of a low-polymer loading treatment fluid (LPLTF) for performing one or more subterranean formation operations. As used herein, the term “low-polymer treatment fluid” or “LPLTF” refers to a treatment fluid comprising less than about 2.4 grams/liter (g/L) of a guar-based gelling agent, in combination with a dual crosslinking additive. The LPLTF is able to replace high-polymer loading treatment fluids that are traditionally used to suspend particulates and deliver them to a downhole location. The LPLTF accordingly exhibits the requisite viscosity to deliver such particulates despite having a low-polymer loading. Accordingly, the costs associated with the LPLTF may be reduced compared to traditional treatment fluids. Moreover, the thermal stability of the LPLTFs described herein are stable up to at least about 149° C. (equivalent to about 300° F.), thus allowing the LPLTFs to be used in a wide array of subterranean formations, including those with extreme temperatures. Gel stabilizers are typically used to impart thermal stability to treatment fluids, but gel stabilizers are ineffective at the low-polymer loadings of the LPLTFs of the present disclosure. Because of the dual crosslinking additive included in the LPLTF, thermal stability can be achieved without any gel stabilizers. As used herein, the term “thermal stability” (as “temperature stability”) with reference to the LPLTF means that the LPLTF provides adequate solids transport at the cited temperature for performing a particular subterranean formation operation. For example, without being bound by theory, the LPLTF may be thermally stable if more than about 70% of suspend solids remain in suspension without settling over a period of 30 minutes time at the cited temperature. Accordingly, the LPLTFs of the present disclosure offer an alternative to more costly, traditional high-polymer loading treatment fluids without being limited based on thermal stability or the type of operation in which it is used.

Of the many advantages of the embodiments described herein, the ability to reduce polymer loading without sacrificing suspension characteristics or thermal stability advantageously reduces costs associated with the polymer as less is needed; reduces damage to formations from gel residue as less polymer is used; and decreases the hydraulic power required to deliver the LPLTF to a downhole location, thereby prolonging the life of pumping equipment, allowing higher flow rate pumping, and allowing longer formation intervals to be treated in a single operation. Moreover, the LPLTF provides friction reduction properties, again allowing a reduction of costs, relief to equipment, and elevated effectiveness and efficiencies of operations.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” As used herein, the term “about” encompasses +/−5% of each numerical value. For example, if the numerical value is “about 80%,” then it can be 80%+/−5%, equivalent to 76% to 84%. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

As used herein, the term “substantially” means largely, but not necessarily wholly.

In some embodiments, the present disclosure provides a LPLTF comprising an aqueous-based fluid, a guar-based gelling agent, and a dual crosslinking additive. The dual crosslinking additive comprises a metal crosslinker and a multifunctional boronic acid (MXL) crosslinker. The combination of the metal crosslinker and the MXL crosslinker synergistically operate together to enhance the viscosity of the LPLTF, despite the low-polymer loading of the LPLTF. Moreover, the combination of the metal crosslinker and the MXL crosslinker synergistically operate together to enhance the thermal stability of the LPLTF. Accordingly, the LPLTF would exhibit reduced viscosity and reduced thermal stability if either of the components of the dual crosslinking additive were alone included in a treatment fluid having a low-polymer loading according to the embodiments of the present disclosure. Without being bound by theory, it is believed that the dual crosslinking additive exhibits these favorable characteristics because the metal crosslinker serves as an auxiliary crosslinker in addition to the MXL crosslinker, and the guar-based gelling agent provides higher thermal stability.

The LPLTF described herein may be used in systems and methods for performing a subterranean formation operation. As described herein, the term “subterranean formation operation” (or simply “formation operation” or “operation”) refers to any intervention, manipulation, or action performed in a subterranean formation that is not a result of a naturally occurring event. Any formation operation that utilizes a treatment fluid requiring a viscous fluid may be performed with the LPLTF described herein. Such treatment fluids may be used to suspend particulates or other solids for delivery to a target location in a formation. Specific formation operations using the LPLTF of the present disclosure include, but are not limited to, a fracturing operation, a frac-packing operation, a gravel packing operation, and combinations thereof where applicable.

The viscosity and thermal stability of the LPLTFs described herein are at least two advantages of the LPLTFs, despite the low-polymer loading thereof. The viscosity of the LPLTFs described herein are in the range of about 100 centipoise (cP) to about 2500 cP at a 40 s⁻¹ shear rate, encompassing any value and subset therebetween. For example, in some embodiments, the viscosity of the LPLTF is about 100 cP to about 580 cP, or about 580 cP to about 1060 cP, or about 1060 cP to about 1540 cP, or about 1540 cP to about 2020 cP, or about 2020 cP to about 2500 cP, or about 400 cP to about 2100 cP, or about 800 cP to about 1700 cP, or about 1200 cP to about 1300 cP, encompassing any value and subset therebetween. The viscosity remains in this range over a period of at least about 30 minutes, although some fluctuation either in the positive or negative direction is possible, without departing from the scope of the present disclosure. Each of these values is critical to the embodiments of the present disclosure and may depend on a number of factors including, but not limited to, the types of components forming the LPLTF, the conditions of the subterranean formation (e.g., temperature, salinity, pressure), the subterranean formation operation being performed, and the like, and any combination thereof.

As stated above, the LPLTFs of the present disclosure are thermally stable at temperatures up to (and in some cases greater) than about 149° C. This temperature of the subterranean formation may be a cool-down temperature, such that in some cases the subterranean formation experiences increased temperatures, such as during certain subterranean formation operations, and then cools-down to a resting temperature of less than about 149° C. As used herein, the term “cool-down temperature” with reference to a subterranean formation means the formations resting temperature when no operations are in progress creating additional heating or cooling. In practice in a subterranean formation, the temperatures encountered by the LPLTF, in which thermal stability is retained, is generally in the range of about 20° C. to about 149° C., encompassing every value and subset therebetween. Each of these values is critical to the embodiments of the present disclosure and may depend on a number of factors including, but not limited to, the types of components forming the LPLTF, the conditions of the subterranean formation (e.g., temperature, salinity, pressure), the subterranean formation operation being performed, and the like, and any combination thereof.

The aqueous-based fluid for use in forming a portion of the LPLTF described herein may be an aqueous fluid or an aqueous-miscible fluid. Suitable aqueous include, but are not limited to, fresh water, saltwater (e.g., water containing one or more salts dissolved therein), brine (e.g., saturated salt water), seawater, produced water (e.g., water produced as a byproduct from a subterranean formation during hydrocarbon production), waste water (e.g., water that has been adversely affected in quality by anthropogenic influence) that is untreated or treated, and any combination thereof.

Suitable aqueous-miscible fluids include, but are not limited to, an alcohol (e.g., methanol, ethanol, n-propanol, isopropanol, n-butanol, sec-butanol, isobutanol, and t-butanol), a glycerin, a glycol (e.g., polyglycols, propylene glycol, and ethylene glycol), a polyglycol amine, a polyol, any derivative thereof, any in combination with a salt (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), any in combination with an aqueous fluid described above, and any combination thereof.

Generally, the water, whether in the aqueous fluid or the aqueous-miscible fluid, may be from any source, provided that it does not contain components that might adversely affect the stability and/or performance of the LPLTFs described herein, such as viscosity and/or thermal stability, and the like.

The guar-based gelling agent is present in an amount of less than about 2.4 g/L of the liquid portion of the LPLTF. In some embodiments, the guar-based gelling agent is present in an amount of from about 0.6 g/L to about 2.4 g/L, encompassing any value and subset therebetween. For example, the guar-based gelling agent may be present in an amount of from about 0.6 g/L to about 0.9 g/L, or about 0.9 g/L to about 1.2 g/L, or about 1.2 g/L to about 1.5 g/L, or about 1.5 g/L to about 1.8 g/L, or about 1.8 g/L to about 2.1 g/L, or about 2.1 g/L to about 2.4 g/L of the liquid portion of the LPLTF, encompassing any value and subset therebetween. In some embodiments, the guar-based gelling agent is present in an amount of about 0.96 g/L, or about 1.7 g/L, or about 2.4 g/L of the liquid portion of the LPLTF. Each of these values is critical to the embodiments of the present disclosure and may depend on a number of factors including, but not limited to, the type(s) of guar-based gelling agent selected, the type of dual crosslinking agent selected, the amount of dual crosslinking agent used, the particular subterranean formation operation, the conditions of the subterranean formation (e.g., temperature, salinity, and the like), the type of aqueous-based fluid selected, and the like, and any combination thereof.

The guar-based gelling agent may be any guar or guar derivative suitable for use in a subterranean formation and for a subterranean formation operation. Suitable guar-based gelling agents for use in forming the LPLTF described herein include, but are not limited to, a guar gum, a hydroxypropyl guar, a hydroxyethyl guar, a carboxymethyl hydroxyethyl guar, a carboxymethyl hydroxypropyl guar, a sodium carboxymethyl guar, an oxidized guar, an aminoethyl guar, a guar gum sulfate (e.g., a sulfate ester), a guar gum grafted with acrylic acid, a guar gum grafted with acrylonitrile, a guar gum grafted with acrylamide, a guar gum grafted with polyacrylamide, a guar gum nitrate ester, and any combination thereof. In some embodiments, subject to the composition of the LPLTF, the guar-based gelling agents may include a guar hydroxypropyltrimonium chloride, a hydroxypropyl guar hydroxypropyltrimonium chloride, any in combination with the aforementioned guar-based gelling agents, and any combination thereof.

The dual crosslinking additive described herein comprises a first metal crosslinker and a second MXL crosslinker. The ratio of the metal crosslinker to the MXL crosslinker (metal crosslinker:MXL crosslinker) may be in the range of from about 1:100 to about 100:1, encompassing any value and subset therebetween. For example, in some embodiments, the ratio of metal crosslinker:MXL crosslinker may be of from about 1:100 to about 20:80, or about 20:80 to about 40:60, or about 40:60 to about 60:40, or about 60:40 to about 80:20, or about 80:20 to about 1:100, encompassing any value and subset therebetween. In preferred embodiments, although non-limiting, the ratio of metal crosslinker:MXL crosslinker may be in the range of from about 1:4 to about 1:10, depending on the particular crosslinkers selected, encompassing any value and subset therebetween. In other preferred embodiments, the metal crosslinker:MXL crosslinker ratio is about 30:100, or about 1:3, or about 1:2, or about 429:1000, or about 60/100, or 30:100, or 1:3, or 1:2, or 429:1000, or 60/100, depending on the particular crosslinkers selected. Each of these values is critical to the embodiments of the present disclosure and may depend on a number of factors including, but not limited to, the type of metal crosslinker, the type of MXL crosslinker, the type of guar-based gelling agent, the type of aqueous-based fluid, the conditions of the subterranean formation, the type of subterranean formation operation, and the like, and combinations thereof.

The dual crosslinking additive, that is the combined metal crosslinker and MXL crosslinker, may be present in the LPLTF in any amount suitable for achieving a desired viscosity. In some embodiments, the dual crosslinking additive is present in an amount of from about 0.001% to about 0.5% weight per volume (w/v) of the liquid portion of the LPLTF. As can be appreciated, the synergistic combination of the components of the dual crosslinking additive permit use of only a small amount of the dual crosslinking additive in the LPLTFs described herein. Accordingly, the dual crosslinking additive may be present in an amount of from about 0.001% to about 0.01%, or about 0.01% to about 0.1%, or about 0.1% to about 0.2%, or about 0.2% to about 0.3%, or about 0.3% to about 0.4%, or about 0.4% to about 0.5%, encompassing any value and subset therebetween. For example, in some embodiments, the dual crosslinking additive may be present in an amount of about 0.06%, or about 0.059%, or about 0.5%, or about 0.048%, or 0.06%, or 0.059%, or 0.5%, or 0.048%.

The metal crosslinker forming a portion of the dual crosslinking additive may be any metal crosslinker capable of synergistically combining with the MXL crosslinker to viscosify the LPLTFs of the present disclosure. Examples of suitable metal crosslinkers include, but are not limited to, a magnesium ion, a zirconium IV ion, a titanium IV ion, an aluminum ion, an antimony ion, a chromium ion, an iron ion, a copper ion, a zinc ion, and any combination thereof. Additionally, these ions may be provided by providing any compound that is capable of producing one or more of these ions. Examples of such compounds include, but are not limited to, magnesium oxide; zirconium lactate; zirconium triethanol amine; zirconium lactate triethanolamine; zirconium carbonate; zirconium acetylacetonate; zirconium malate; zirconium citrate; zirconium diisopropylamine lactate; zirconium glycolate; zirconium triethanol amine glycolate; zirconium lactate glycolate; titanium lactate; titanium malate; titanium citrate; titanium ammonium lactate; titanium triethanolamine; titanium acetylacetonate; aluminum lactate; aluminum citrate; antimony compounds; chromium compounds; iron compounds; copper compounds; zinc compounds; and any combinations thereof.

In some embodiments, the metal ion is a titanium-based crosslinker comprising titanium IV ions. Such titanium IV ions may be directly supplied or in the form of a compound including, but not limited to, titanium lactate, titanium malate, titanium citrate, titanium ammonium lactate, titanium triethanol amine, and titanium acetylacetonate, titanium tetrachloride, titanium tetrabromide, titanium oxide, titanium nitrate, titanium sulfate, titanium carbonate, titanium cyanide, titanium acetate, titanium hydroxide, titanium chromate, titanium nitride, titanium hydochlorite, titanium phosphate, titanium dichromate, titanium nitrite, titanium borate, and any combination thereof.

The MXL crosslinker may be di-, tri-, or multifunctional in nature. Except as otherwise made explicit, as used herein, the term “multifunctional” encompasses such di-, tri-, and multifunctional molecules. In some embodiments, the MXL crosslinker may be star shaped or dendritic shaped. The MXL crosslinker may also be polymeric in nature. In some embodiments, a polymeric MXL crosslinker may be a block copolymer (e.g., a diblock, triblock, or multiblock copolymer) or a copolymer of various monomers and in the form of a comb or brush shaped polymer. In still other embodiments, the MXL crosslinker may be water-soluble.

In some embodiments, the MXL crosslinker may be star shaped or dendritic shaped. An example of an exemplary structure of a dendritic shaped MXL crosslinker is shown in Formula I:

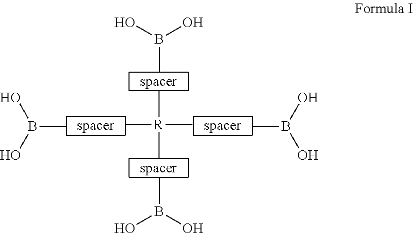

As used herein, the terms “dendritic polymers” or “dendrimers” refer to polymers that are characterized by a branched structure. Dendrimers (e.g., cascade polymers, arborols, isotropically branched polymers, isobranched polymers, starburst polymers, and the like) generally are macromolecules which are uniform at the molecular level and have a highly symmetrical structure. Dendrimers are derived structurally from the star polymers, the individual chains in turn each being branched in a star-like manner. They may form from small molecules by a constantly repeating reaction sequence, resulting in one or more branches on the ends of which there are in each case functional groups which in turn are starting points for further branching. Thus, the number of functional terminal groups multiplies with each reaction step. A characteristic feature of the dendrimers is the number of reaction steps (generations) carried out for their synthesis. Owing to their uniform structure, dendrimers can have as a rule a defined molar mass. In some embodiments, the multifunctional boronic crosslinkers may be dendritic-shaped with about 2 to about 10 generations. In another embodiment, the dendritic-shaped multifunctional boronic crosslinkers may have about 2 to about 5 generations. In other embodiments, the dendritic-shaped multifunctional boronic acid crosslinking agents may have a molecular weight between about 0.5 megadaltons (MDa) to about 5 MDa, encompassing any value and subset therebetween. Accordingly, the dendritic-shaped multifunctional boronic acid crosslinking agents may have a molecular weight of from about 0.5 MDa to about 1 MDa, or about 1 MDa to about 1.5 MDa, or about 1.5 MDa to about 2 MDa, or about 2 MDa to about 2.5 MDa, or about 2.5 MDa to about 3 MDa, or about 3 MDa to about 3.5 MDa, or about 3.5 MDa to about 4 MDa, or about 4 MDa to about 4.5 MDa, or about 4.5 MDa to about 5 MDa, encompassing any value and subset therebetween.

Star polymers refer to polymers in which three or more chains extend from a center moiety. The center moiety can be a single atom or a group of atoms. Star polymers can be produced either by polymerization from multifunctional cores or by post modification reactions. Polymerization from a multifunctional core may be desirable for high molecular weight polymers.

The dendritic or star polymeric MXL crosslinkers described in some embodiments herein may comprise any suitable monomer units and/or spacer units (e.g., “R” or “spacer” in Formula I) that result in a water-soluble molecule in addition to one or more boronic acid groups. In some embodiments, the monomer units can be water-soluble monomers. For example, Formula I illustrates a dendritic MXL crosslinker with at least one generation that may have up to four boronic acid groups. In some embodiments with at least 2 generations, the dendritic MXL crosslinker may have up to eight boronic acid groups in the outer generation. In addition to the boronic acid group, the spacer units shown in Formula I may comprise a polymer or oligomer synthesized from at least one water-soluble monomer.

In general, the boronic acid group comprises the formula R—B—(OH)₂, and may be derived from a boronate ester, for example. Water-soluble monomers that may be suitable as the “R” or “spacer” units in the dendritic MXL crosslinkers may include, but are not limited to, acrylamide; 2-acrylamido-2-methyl propane sulfonic acid; N,N-dimethylacrylamide; vinyl pyrrolidone; dimethylaminoethyl methacrylate; acrylic acid; dimethylaminopropylmethacrylamide; vinyl amine; vinyl acetate; trimethylammoniumethyl methacrylate chloride; methacrylamide; hydroxyethyl acrylate; vinyl sulfonic acid; vinyl phosphonic acid; vinylbenzene sulfonic acid; methacrylic acid; vinyl caprolactam; N-vinylformamide; diallyl amine; N,N-diallylacetamide; dimethyldiallyl ammonium halide; itaconic acid; styrene sulfonic acid; methacrylamidoethyltrimethyl ammonium halide; a quaternary salt derivative of an acrylamide; a quaternary salt derivative of an acrylic acid; an alkyl acrylate; an alkyl methacrylate; alkyl acrylamide; alkyl methacrylamide; alkyl dimethylammoniumethyl methacrylate halide; alkyl dimethylammoniumethyl methacrylamide halide; alkyl dimethylammoniumpropyl methacrylamide halide; alkyl dimethylammoniumpropyl methacrylate halide; any derivative thereof, and any combination thereof. Suitable spacer units may also comprise any suitable linkage moieties, including but not limited to, an amide; an ester; an ether; a phosphate ester; an acetal; a ketal; an orthoester; a carbonate; an anhydride; a silyl ether; an alkene oxide; an imine; an ether ester; an ester amide; an ester urethane; a carbonate urethane; an amino acid; an alkane; a polyethylene amine; a polyethylene oxide; a polyester; polycarbonate; polyurethane; polyphosphate ester; a polyamide; a polyacetal; a polyketal; a polyorthoester; a polyanhydride; a polysilyl ether; a poly(alkene oxide); a polyether; a polyimine; a poly(ether ester); a poly(ester amide); a poly(ester urethane); a poly(carbonate urethane); a poly(amino acid); poly(vinyl imidazole); any derivative thereof; and any combination thereof. As used herein, the term “derivative” refers to any compound that is made from one of the listed compounds, for example, by replacing one atom in one of the listed compounds with another atom or group of atoms, ionizing one of the listed compounds, or creating a salt of one of the listed compounds.

In addition to the water-soluble monomers described above for use in some embodiments herein, one or more hydrophobic and/or hydrophilic monomer or polymer units comprising hydrophobic monomers may also be present, so long as any hydrophobic monomer units do not interfere with the water solubility of the molecule. In some embodiments, the dendritic or star MXL crosslinkers may have a ratio of boronic acid groups to monomers (boronic acid groups: monomers) in the range of from about 1:1 to about 1:800, encompassing any value and subset therebetween. For example, the ratio of boronic acid groups:monomers may be of from about 1:1 to about 1:160, or about 1:160 to about 1:320, or about 1:320 to about 1:480, or about 1:480 to about 1:640, or about 1:640 to about 1:800, encompassing any value and subset therebetween. Each of these values is critical to the embodiments of the present disclosure and may depend on a number of factors including, but not limited to, the desired water-solubility of the MXL crosslinker, the selected metal crosslinker, the selected guar-based gelling agent, the selected aqueous-based fluid, and the like, and any combination thereof. Therefore, the embodiments herein may comprise MXL crosslinkers having a particularly low boronic acid content without compromising their functionality in the LPLTF as part of the dual crosslinking additive.

In some embodiments, the MXL crosslinker may be a di-functionalized or tri-functionalized molecule. By way of example, an exemplary structure of a di-functionalized boronic crosslinker is shown in Formula II.

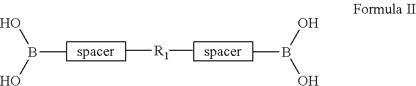

In Formula II, R₁ and/or the spacer units, alone or in combination, may be a functional group, a monomer, and/or a polymer with an average molecular weight in the range of about 200 Daltons to about 2,000,000 Daltons, encompassing any value and subset therebetween. The spacer units may be a small oligomer, a functional group, or a polymer suitable for connecting the monomer or polymer R₁ to at least one boronic acid group. Suitable spacer units can comprise any suitable moieties, including but not limited to, an amide group; an ester group; an ether group; and any combination thereof. Suitable polymers useful as spacer units may include, but are not limited to, a polyalphaolefin; a polyaryletherketone; a polybutene; a polyimine; a polycarbonate; a polyester; an aromatic polyamide; an ethylene vinyl acetate polymer; a polyacetal; a polyethylene; a polyethylene oxide; a polypropylene; a polymethylpentene; a polyphenylene oxide; a polystyrene; any derivative thereof; and any combination thereof. In some embodiments, the MXL crosslinkers of the general structure shown in Formula II may be water-soluble, comprising, where appropriate, any of the water-soluble monomer(s) disclosed above with reference to the dendritic MXL crosslinkers. In some embodiments, a di-functional or tri-functional boronic crosslinker disclosed herein (as discussed above, collectively referred to herein as MXL crosslinkers) may have a ratio of boronic acid groups to monomers in the range of from about 1:1 to about 1:800, as discussed above, encompassing every value and subset therebetween. Therefore, the embodiments herein may comprise MXL crosslinkers having a particularly low boronic acid content without compromising their functionality in the LPLTF as part of the dual crosslinking additive.

The MXL crosslinkers may also be a copolymer. Suitable copolymer structures include, but are not limited to, the structure generally represented by Formula III, where X represents a functional group bound to a monomer unit of the polymer backbone. Although Formula III as shown indicates a regular spacing between boronic acid monomers, it is to be recognized that the spacing of boronic acid monomers can be regular in some embodiments or random in other embodiments.

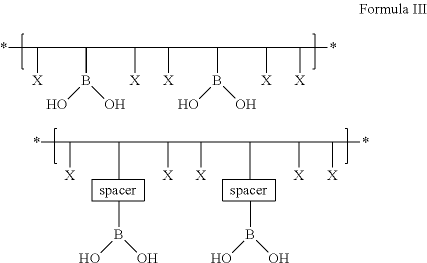

In some embodiments, the polymeric MXL crosslinker may be a block copolymer including, but not limited to, a diblock, triblock, or multiblock copolymer. An exemplary embodiment of a suitable diblock copolymer structure may include, but is not limited to, the structure represented by Formula IV.

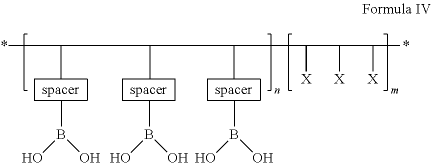

The copolymers and block copolymers of Formulas III and IV may have an average molecular weight in the range of from about 500 kilodaltons (kDa) to 5 MDa, encompassing any value and subset therebetween. For example, the average molecular weight of the copolymers and block polymers of Formulas III and IV may be from about 500 kDa to about 1000 kDa, or about 1000 kDa to about 1.5 MDa, or about 1.5 MDa to about 2 MDa, or about 2 MDa to about 2.5 MDa, or about 2.5 MDa to about 3 MDa, or about 3 MDa to about 3.5 MDa, or about 3.5 MDa to about 4 MDa, or about 4 MDa to about 4.5 MDa, or about 4.5 MDa to about 5 MDa, encompassing any value and subset therebetween.

The copolymers and block copolymers of Formulas III and IV may be formed by a polymerization reaction of a boronic acid monomer and a water-soluble monomer. Formulas III and IV illustrate that a boronic functional group may be directly bonded to the backbone of the polymer and/or the boronic functional group may be connected to the backbone of the polymer with an intervening spacer group between the boronic functional group and the backbone of the polymer.

In general, in some embodiments, the boronic acid monomer may comprise a vinyl, allyl or acrylic functional group. In some embodiments, the boronic acid monomer may comprise an aryl boronic acid or particularly a vinyl boronic acid. In other embodiments, the boronic acid monomer may comprise an alkyl, alkenyl, or alkynyl boronic acid (i.e., aliphatic boronic acids). It should be noted that the classification of a boronic acid as allyl, aryl, alkyl, alkenyl, or alkynyl for use as the boronic acid monomer described herein, refers to the point of attachment of the boronic acid group. That is, for example, an aryl boronic acid has a boronic acid group or a boronate ester derivative thereof attached to an aryl ring, and an alkenyl boronic acid has a boronic acid or boronate ester derivative thereof attached to an alkenyl group. The boronic acid monomers and the boronic acid groups, as described herein, may have additional functionality elsewhere in the molecule that is not attached to the boronic acid functionality. For example, an aryl boronic acid can have an alkenyl functionality elsewhere in the molecule that is not attached to the boronic acid functionality. Suitable boronic acid monomers may be any acrylamide boronic acid monomer. Specific examples of suitable boronic acid monomers include, but are not limited to, 3-acrylamidophenyl boronic acid monomer; 2-acrylamidophenylboronic acid monomer; 4-acrylamido phenyl boronic acid; 2-((2-acrylamidoethylamino)methyl)phenyl boronic acid; any isomers thereof; any derivative thereof; and any combination thereof.

Water-soluble boronic monomers for use in the polymeric MXL crosslinkers disclosed herein include, but are not limited to, Water-soluble monomers that may be suitable as the “R” or “spacer” units in the dendritic MXL crosslinkers include, but are not limited to, acrylamide; 2-acrylamido-2-methyl propane sulfonic acid; N,N-dimethylacrylamide; vinyl pyrrolidone; dimethylaminoethyl methacrylate; acrylic acid; dimethylaminopropylmethacrylamide; vinyl amine; vinyl acetate; trimethylammoniumethyl methacrylate chloride; methacrylamide; hydroxyethyl acrylate; vinyl sulfonic acid; vinyl phosphonic acid; vinylbenzene sulfonic acid; methacrylic acid; vinyl caprolactam; N-vinylformamide; diallyl amine; N,N-diallylacetamide; dimethyldiallyl ammonium halide; itaconic acid; styrene sulfonic acid; methacrylamidoethyltrimethyl ammonium halide; a quaternary salt derivative of an acrylamide; a quaternary salt derivative of an acrylic acid; an alkyl acrylate; an alkyl methacrylate; alkyl acrylamide; alkyl methacrylamide; alkyl dimethylammoniumethyl methacrylate halide; alkyl dimethylammoniumethyl methacrylamide halide; alkyl dimethylammoniumpropyl methacrylamide halide; alkyl dimethylammoniumpropyl methacrylate halide; any derivative thereof, and any combination thereof. Other functional groups can also be present along the polymer backbone. In some embodiments, the boronic acid functional group can be grafted onto an already formed polymer backbone using techniques known to one having ordinary skill in the art. In some embodiments, as generally represented by Formulas III and VI, the ratio of the boronic acid monomer units to the other monomer units in the polymer may range from about 1:1 to about 1:80, as described above, encompassing any value and subset therebetween. Therefore, the embodiments herein may comprise MXL crosslinkers having a particularly low boronic acid content without compromising their functionality in the LPLTF as part of the dual crosslinking additive.

In some embodiments, the MXL crosslinkers may comprise an equilibrium species. For example, the MXL crosslinkers may become protonated or deprotonated depending on pH. This feature can influence their solubility in a treatment fluid. Likewise, intramolecular interactions between atoms in the MXL crosslinkers and the geometry of boron (e.g., tetrahedral or trigonal planar) may depend on pH and/or solvent (e.g., an alcohol-based solvent such as methanol). Thus, the exact chemical composition and geometry of the MXL crosslinkers may depend on a particular equilibrium known to one of ordinary skill in the art. The geometry can also depend on the neighboring group participation in changing the steoreochemistry. For example, a nitrogen atom present in a neighboring group may share its lone pair of electrons with a boron to result in a tetrahedral geometry, which can allow for the formation of a bond to hydroxyl groups at a relatively neutral pH.

The LPLTF of the present disclosure may further comprise an additive selected from the group consisting of a surfactant, a buffering agent, a proppant, a solid particulate, a salt, a weighting agent, a fluid loss control agent, a corrosion inhibitor, a lost circulation material, a foaming agent, a gas, a breaker, a biocide, a chelating agent, a scale inhibitor, a friction reducer, a clay stabilizing agent, and any combination thereof.

One or more surfactants may be included in the LPLTF to improve the compatibility of the various components of the LPLTF with formation fluids (i.e., fluids originating from the subterranean formation), including formation brines and formation hydrocarbons, for example. The surfactants aid in fluid recovery by minimizing fluid blockage. When included, the surfactant(s) may be present in the LPLTF in an amount in the range of from about 0.05% to about 1% by volume of the liquid portion of the LPLTF, encompassing any value and subset therebetween. For example, the surfactant may be present of from about 0.05% to about 0.2%, or about 0.2% to about 0.4%, or about 0.4% to about 0.6%, or about 0.6% to about 0.8%, or about 0.8% to about 1%, or about 0.2% to about 0.8%, or about 0.4% to about 0.6%, each by volume of the liquid portion of the LPLTF, encompassing any value and subset therebetween. Each of these values is critical to the embodiments herein and may depend on a number of factors including, but not limited to, the desired functionality of the surfactant within the LPLTF, the types and amounts of the other components of the LPLTF including additional additives, the particular subterranean formation operation, and the like, and any combination thereof.

Surfactants for use in the LPLTF described herein may include, but are not limited to, nonionic surfactants (e.g., alcohol ethoxylates), cationic surfactants, anionic surfactants, amphoteric/zwitterionic surfactants, alkyl phosphonate surfactants, linear alcohols, nonylphenol compounds, alkyoxylated fatty acids, alkylphenol alkoxylates, ethoxylated amides, ethoxylated alkyl amines, betaines, methyl ester sulfonates, hydrolyzed keratin, sulfosuccinates, taurates, amine oxides, alkoxylated fatty acids, alkoxylated alcohols, lauryl alcohol ethoxylate, ethoxylated nonyl phenol, ethoxylated fatty amines, ethoxylated alkyl amines, cocoalkylamine ethoxylate, betaines, modified betaines, alkylamidobetaines, cocamidopropyl betaine, or combinations thereof.

A buffering agent may be included in the LPLTF to achieve a desired pH value or range of the LPLTF. In some embodiments, the desired pH is in the range of about 7 to about 12, encompassing any value and subset therebetween. For example, the pH of the LPLTF may be about 7, about 8, about 9, about 10, about 11, about 12, encompassing any value and subset therebetween. This range of pH is desirable because at higher pH ranges, the LPLTF retains higher thermal stability. Thus, the amount and type of buffering agent is selected to achieve the desired pH value or range for a particular operation, formation type, and the like. Accordingly, each of the foregoing values is critical to the embodiments of the present disclosure and may depend on a number of factors including, but not limited to, the particular subterranean formation operation being performed, the additional components of the LPLTF including additives, and the like, and any combination thereof.

The buffering agent may be any acid or base capable of affecting the pH of the LPLTF, provided that it does not otherwise interfere with the properties of the LPLTF, such as viscosity and/or thermal stability. Examples of suitable acids for use as the buffering agent include, but are not limited to, formic acid, acetic acid, glacial acetic acid, monochloroacetic acid, dichloroacetic acid, trichloroacetic acid, hydrochloric acid, nitric acid, sulphuric acid, sulphonic acid, sulphinic acid, methanesulfonic acid, sulphamic acid, lactic acid, glycolic acid, oxalic acid, propionic acid, butyric acid, and any combination thereof. Suitable bases for use as the buffering agent include, but are not limited to, sodium hydroxide, potassium hydroxide, lithium hydroxide, sodium carbonate, sodium bicarbonate, potassium carbonate, potassium bicarbonate, ammonium hydroxide, anhydrous ammonia, and any combination thereof.

The LPLTF may further include a solid particulate. Such solid particulates include proppant and/or gravel particulates included in the LPLTF for performing at least hydraulic fracturing operation, a gravel packing operation, and/or a frac-packing operation, as described above. Accordingly, the term “solid particulates,” and grammatical variants thereof, includes at least proppant particulates and gravel particulates. The solid particulates for inclusion in the LPLTF described herein may be any material naturally-occurring or man-made, which is suitable for use in a subterranean formation and appropriate for use in the embodiments as described herein (e.g., for forming a gravel or proppant pack). Suitable materials for forming the solid particulates described herein may include, but are not limited to, gravel (e.g., unconsolidated rock fragments), sand (e.g., desert sand, beach sand), cementitious material (e.g., Portland cement, Portland cement blends (e.g., blast-furnace slag), and non-Portland cement (e.g., super-sulfated cement, calcium aluminate cement, high magnesium-content cement, and the like), and the like), bauxite, alumino-silicate material, ceramic material (e.g., ceramic microspheres), glass material, polymeric material (e.g., ethylene-vinyl acetate or composite materials), metal (e.g., alkali metals, alkaline earth metals, transition metals, post-transition metals, metalloids), zeolites, polytetrafluoroethylene material, thermoplastic material (e.g., nylon thermoplastic) nut shell pieces, a cured resinous particulate comprising nut shell pieces, seed shell pieces, a cured resinous particulate comprising seed shell pieces, fruit pit pieces, a cured resinous particulate comprising fruit pit pieces, wood, composite particulates, and any combination thereof. Suitable composite solid particulates may comprise a binder and a filler material, wherein suitable filler materials may include, but are not limited to, silica, alumina, fumed carbon, carbon black, graphite, mica, titanium dioxide, barite, meta-silicate, calcium silicate, kaolin, talc, zirconia, boron, fly ash, hollow glass microspheres, solid glass, nanoparticulates, and any combination thereof.

The shape of the solid particulates may be such that they are substantially spherical or substantially non-spherical, which may be cubic, polygonal, fibrous, or any other non-spherical shape. Such substantially non-spherical solid particulates may be, for example, cubic-shaped, rectangular-shaped, rod-shaped, ellipse-shaped, cone-shaped, pyramid-shaped, cylinder-shaped, platelet-shaped, and any combination thereof. That is, in embodiments wherein the solid particulates are substantially non-spherical, the aspect ratio of the material may range such that the material is fibrous to such that it is cubic, octagonal, or any other configuration.

The solid particulates for use in the LPLTFs described may have a particle size distribution in the range of from about 40 micrometers (μm) to about 1400 μm, encompassing any value and subset therebetween. For example, the solid particulates may have a particle size distribution of from about 40 μm to about 312 μm, or about 312 μm to about 584 μm, or about 584 μm to about 856 μm, or about 856 μm to about 1128 μm, or about 1128 μm to about 1400 μm, or about 290 μm to about 1150 μm, or about 540 μm to about 900 μm, or about 790 μm to about 650 μm, encompassing any value and subset therebetween. Each of these values is critical to the embodiments of the present disclosure and may depend on a number of factors including, but not limited to, the particular use of the solid particulates (e.g., gravel pack and/or proppant pack), the size of a fracture for forming a proppant pack, the size of an annulus for packing and forming a gravel pack, the size and type of unconsolidated particles in the formation, and the like, and any combination thereof.

The solid particulates may be included in the LPLTF in an amount in the range of about 1 pound (lb) to about 8 lb by 1-gallon (gal) volume (expressed as lb/gal) of the liquid portion of the LPLTF, encompassing any value and subset therebetween. One lb/gal is equivalent to 119.96 grams per liter (g/L). In some embodiments, for example, the solid particulates may be in the LPLTF of from about 1 lb/gal to about 2.4 lb/gal, or about 2.4 lb/gal to about 3.8 lb/gal, or about 3.8 lb/gal to about 5.2 lb/gal, or about 5.2 lb/gal to about 6.6 lb/gal, or about 6.6 lb/gal to about 8 lb/gal, or about 1.5 lb/gal to about 6.5 lb/gal, or about 3 lb/gal to about 5 lb/gal of the liquid portion of the LPLTF, encompassing any value and subset therebetween. Each of these values is critical to the embodiments of the present disclosure and may depend in a number of factors including, but not limited to, the gravel and/or proppant pack type and size to be formed, the particular subterranean formation operation being performed, the size selected for the solid particulates, and the like, and any combination thereof.

In various embodiments, systems configured for delivering the LPLTFs described herein to a downhole location are described, such as during a hydraulic fracturing operation, a frac-packing operation, and/or a gravel packing operation. In various embodiments, the systems can comprise a pump fluidly coupled to a tubular, the tubular containing a LPLTF comprising an aqueous-based fluid, a guar-based gelling agent in an amount of less than about 2.4 g/L of the liquid portion of the LPLTF, and a dual crosslinking additive comprising a metal crosslinker and a multifunctional boronic acid crosslinker in a ratio in the range of about 1:100 to about 100:1, wherein the LPLTF is thermally stable up to about 149° C.

The pump may be a high-pressure pump in some embodiments. As used herein, the term “high pressure pump” will refer to a pump that is capable of delivering a fluid downhole at a pressure of about 1000 psi or greater. A high-pressure pump may be used when it is desired to introduce the LPLTF to a subterranean formation at or above a fracture gradient of the subterranean formation, but it may also be used in cases where fracturing is not desired. In some embodiments, the high-pressure pump may be capable of fluidly conveying particulate matter, such as proppant particulates, into the subterranean formation. Suitable high-pressure pumps will be known to one having ordinary skill in the art and may include, but are not limited to, floating piston pumps and positive displacement pumps.

In other embodiments, the pump may be a low-pressure pump. As used herein, the term “low pressure pump” will refer to a pump that operates at a pressure of about 1000 psi or less. In some embodiments, a low-pressure pump may be fluidly coupled to a high-pressure pump that is fluidly coupled to the tubular. That is, in such embodiments, the low-pressure pump may be configured to convey the LPLTF to the high-pressure pump. In such embodiments, the low-pressure pump may “step up” the pressure of the LPLTF before it reaches the high-pressure pump.

In some embodiments, the systems described herein can further comprise a mixing tank that is upstream of the pump and in which the LPLTF is formulated. In various embodiments, the pump (e.g., a low-pressure pump, a high-pressure pump, or a combination thereof) may convey the LPLTF from the mixing tank or other source of the LPLTF to the tubular. In other embodiments, however, the LPLTF can be formulated offsite and transported to a worksite, in which case the LPLTF may be introduced to the tubular via the pump directly from its shipping container (e.g., a truck, a railcar, a barge, or the like) or from a transport pipeline. In either case, the LPLTF may be drawn into the pump, elevated to an appropriate pressure, and then introduced into the tubular for delivery downhole.

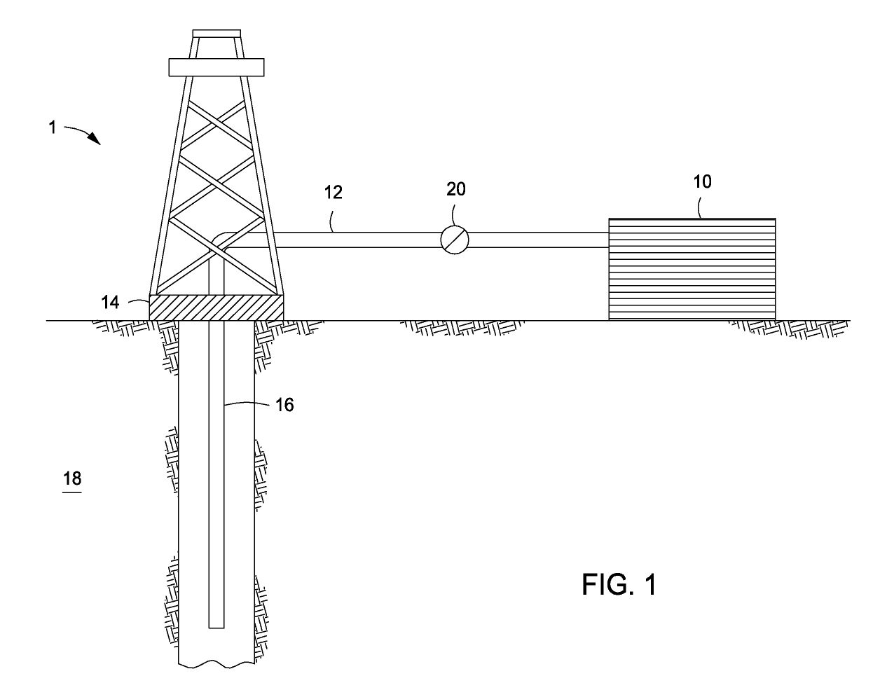

FIG. 1 shows an illustrative schematic of a system that can deliver LPLTFs of the present invention to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a LPLTF of the present invention may be formulated. The LPLTF may be conveyed via line 12 to wellhead 14, where the LPLTF enters tubular 16, tubular 16 extending from wellhead 14 into subterranean formation 18. Upon being ejected from tubular 16, the LPLTF may subsequently penetrate into subterranean formation 18. In some instances, tubular 16 may have a plurality of orifices (not shown) through which the LPLTF of the present disclosure may enter the wellbore proximal to a portion of the subterranean formation 18 to be treated. In some instances, the wellbore may further comprise equipment or tools (not shown) for zonal isolation of a portion of the subterranean formation 18 to be treated.

Pump 20 may be configured to raise the pressure of the LPLTF to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the LPLTF may, in some embodiments, flow back to wellhead 14 and exit subterranean formation 18. In some embodiments, the LPLTF that has flowed back to wellhead 14 may subsequently be recovered and recirculated to subterranean formation 18. In other embodiments, the LPLTF may be recovered and used in a different subterranean formation, a different operation, or a different industrial application.

It is also to be recognized that the disclosed LPLTFs may also directly or indirectly affect the various downhole equipment and tools that may come into contact with the LPLTFs during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include:

### Embodiment A

A method comprising: introducing a low-polymer loading treatment fluid (LPLTF) into a subterranean formation, wherein the LPLTF comprises an aqueous-based fluid, a guar-based gelling agent in an amount of less than about 2.4 grams/liter of the liquid portion of the LPLTF, and a dual crosslinking additive comprising a metal crosslinker and a multifunctional boronic acid crosslinker in a ratio in the range of about 1:100 to about 100:1, and wherein the LPLTF is thermally stable up to about 149° C.; and performing a subterranean formation operation with the LPLTF at a target interval.

### Embodiment B

A system comprising: a tubular extending into a subterranean formation; and a pump fluidly coupled to the tubular, the tubular containing a low-polymer loading treatment fluid (LPLTF) comprising an aqueous-based fluid, a guar-based gelling agent in an amount of less than about 2.4 grams/liter of the liquid portion of the LPLTF, and a dual crosslinking additive comprising a metal crosslinker and a multifunctional boronic acid crosslinker in a ratio in the range of about 1:100 to about 100:1, wherein the LPLTF is thermally stable up to about 149° C.

### Embodiment C

A low-polymer loading treatment fluid (LPLTF) comprising: an aqueous-based fluid; a guar-based gelling agent in an amount of less than about 2.4 grams/liter of the liquid portion of the LPLTF; and a dual crosslinking additive comprising a metal crosslinker and a multifunctional boronic acid crosslinker in a ratio in the range of about 1:100 to about 100:1, wherein the LPLTF is thermally stable up to about 149° C.

Each of Embodiments A, B and C may have one or more of the following additional elements in any combination:

Element 1: Wherein the dual crosslinking additive is present in the range of about 0.001% to about 0.5% weight per volume of the liquid portion of the LPLTF.

Element 2: Wherein the metal crosslinker is selected from the group consisting of a magnesium ion, a zirconium IV ion, a titanium IV ion, an aluminum ion, an antimony ion, a chromium ion, an iron ion, a copper ion, a magnesium ion, a zinc ion, and any combination thereof.

Element 3: Wherein the metal crosslinker is a titanium-based crosslinker comprising titanium IV ions or a compound capable of supplying titanium IV ions, the compound selected from the group consisting of titanium lactate, titanium malate, titanium citrate, titanium ammonium lactate, titanium triethanol amine, and titanium acetylacetonate, titanium tetrachloride, titanium tetrabromide, titanium oxide, titanium nitrate, titanium sulfate, titanium carbonate, titanium cyanide, titanium acetate, titanium hydroxide, titanium chromate, titanium nitride, titanium hydochlorite, titanium phosphate, titanium dichromate, titanium nitrite, titanium borate, and any combination thereof.

Element 4: Wherein the multifunctional boronic acid crosslinker comprises a copolymer including at least one boronic acid monomer unit and at least one water-soluble monomer unit.

Element 5: Wherein the guar-based gelling agent is present in an amount of about 0.6 grams/liter to about 2.4 grams/liter of the liquid portion of the LPLTF.

Element 6: Wherein the LPLTF further comprises an additive selected from the group consisting of a surfactant, a buffering agent, a solid particulate, and any combination thereof.

Element 7: Wherein the multifunctional boronic acid crosslinker comprises a copolymer including at least one boronic acid monomer unit and at least one water-soluble monomer unit, and wherein the at least one boronic acid monomer unit is selected from the group consisting of an aryl boronic acid, an alkyl boronic acid, an alkenyl boronic acid, an alkynyl boronic acid boronic acid, and any combination thereof.

Element 8: Wherein the multifunctional boronic acid crosslinker comprises a copolymer including at least one boronic acid monomer unit and at least one water-soluble monomer unit, and wherein the at least one water-soluble monomer unit is selected from the group consisting of an acrylamide, a 2-acrylamido-2-methyl propane sulfonic acid, a N,N-dimethylacrylamide, a vinyl pyrrolidone, a dimethylaminoethyl methacrylate, an acrylic acid, a dimethylaminopropylmethacrylamide, a vinyl amine, a vinyl acetate, a trimethylammoniumethyl methacrylate chloride, a methacrylamide, a hydroxyethyl acrylate, a vinyl sulfonic acid, a vinyl phosphonic acid, a vinylbenzene sulfonic acid, a methacrylic acid, a vinyl caprolactam, a N-vinylformamide, a diallyl amine, a N,N-diallylacetamide, a dimethyldiallyl ammonium halide, an itaconic acid, a styrene sulfonic acid, a methacrylamidoethyltrimethyl ammonium halide, a quaternary salt derivative of acrylamide, a quaternary salt derivative of acrylic acid, an alkyl acrylate, an alkyl methacrylate, an alkyl acrylamide, an alkyl methacrylamide, an alkyl dimethylammoniumethyl methacrylate halide, an alkyl dimethylammoniumpropyl methacrylamide halide, any derivative thereof, and any combination thereof.

Element 9: Wherein when the LPLTF is introduced into a subterranean formation or in a tubular extending into a subterranean formation, the subterranean formation has a cool-down temperature of less than about 149° C. at the target interval.

Element 10: Wherein when the LPLTF is introduced into a subterranean formation or in a tubular extending into a subterranean formation, the subterranean formation operation to be or being performed is selected from the group consisting of a fracturing operation, a frac-packing operation, a gravel packing operation, and any combination thereof.

By way of non-limiting example, exemplary element combinations applicable to Embodiment A, B and/or C include: 1, 3, 5, and 10; 1-10; 8, and 9; 4, 6, 7, and 9; 2 and 10; 3 and 6; 1, 7, and 8; and the like.

To facilitate a better understanding of the embodiments of the present invention, the following example of preferred or representative embodiments is given. In no way should the following example be read to limit, or to define, the scope of the present disclosure.

### Example 1

In this example, the synergistic effect of the combination of the metal crosslinker and MXL crosslinker of the dual crosslinking additive forming a portion of a LPLTF was evaluated at 200° F. Five treatment fluids were prepared, including a metal crosslinker-only control (M_{only}), a MXL crosslinker-only control (MXL_{only}), and three separate LPLTFs (LPLTF1-LPLTF4). Each of the fluids included 14 pounds per 1000 gallons (lb/1000 gal) (equivalent to 1.68 g/L) of a guar-based gelling agent (hydroxypropyl guar), 2 gallons per 1000 gallons (gal/1000 gal) (equivalent to 2 liters per 1000 liters) of a nonionic surfactant (alcohol ethoxylate), a cocktail of buffering agents (glacial acetic acid, anhydrous ammonia, potassium carbonate, and sodium hydroxide) to achieve a final pH of between 11 and 12, and an amount of one or both, depending on whether the sample is a control or an LPLTF, of a metal crosslinker (a titanium-based crosslinker) and/or a MXL crosslinker.

Initially, the guar-based gelling agent was hydrated in a 1 L blender, after adjusting the pH to 6.5-7.0. Thereafter, a 250 mL aliquot was obtained for each fluid and the single crosslinker or dual crosslinking additive was added, according to Table 1 below. Each fluid was then stirred in the blender for 1 minute and the pH adjusted to a final pH between 11 and 12. In Table 1, the symbol “--” indicates that the particular component was not included in the fluid.

TABLE 1

| | Metal Crosslinker | MXL Crosslinker | pH |
|---|---|---|---|
| M_{only} | 1.5 gal/1000 gal | — | 11.15 |
| MXL_{only} | — | 4 gal/1000 gal | 12 |
| LPLTF1 | 1.5 gal/1000 gal | 3.5 gal/1000 gal | 11.15 |
| LPLTF2 | 1.5 gal/1000 gal | 2.5 gal/1000 gal | 11.15 |
| LPLTF3 | 1.5 gal/1000 gal | 3 gal/1000 gal | 11.15 |

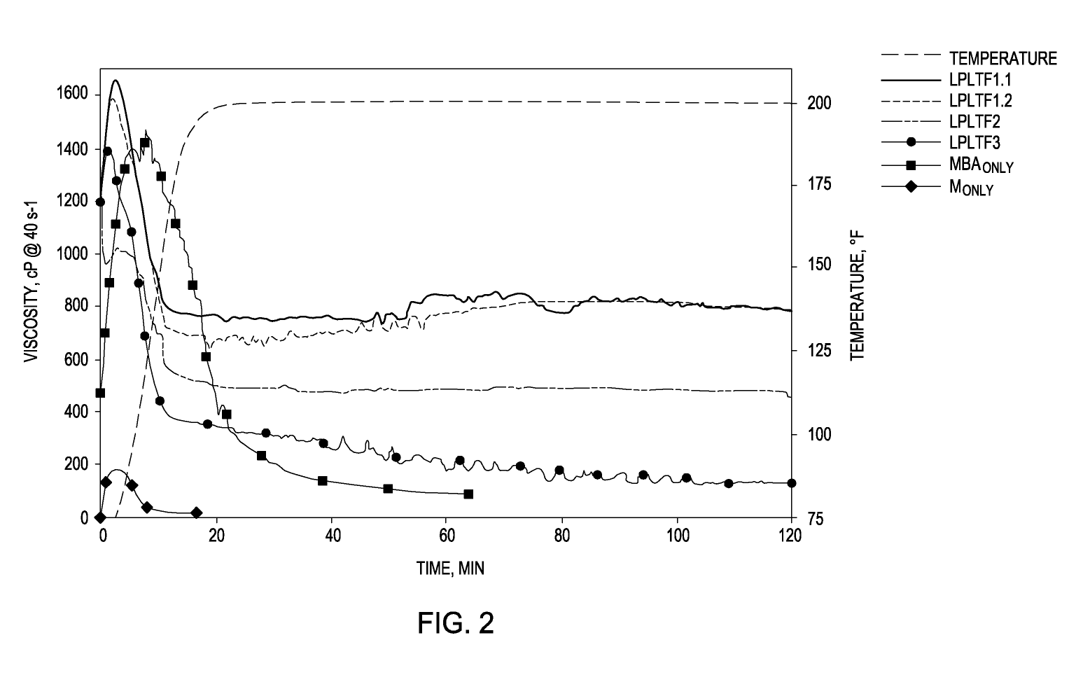

A 44 mL sample of each fluid was placed into a Chandler Model 5550 HPHT Viscometer equipped with a R1 rotor and B5X bob. Tests were performed using a heat-up profile to 200° F. at a 40 s-1 shear rate. The rheological results were obtained using the viscometer for each fluid, and LPLTF1 was tested twice (LPLTF1.1 and LPLTF1.2). The results are shown in FIG. 2. As depicted, each of the LPLTFs exhibited greater viscosity and thermal stability over a prolonged period of time compared to that of the M_{only} and MXL_{only} control fluids, establishing the synergistic behavior of the dual crosslinking additives described herein. This was true even when the total amount of dual crosslinking additive was less than that of a single crosslinker (e.g., the MXL crosslinker). Additionally, increased viscosity and to a lesser extent increased thermal stability was observed as the MXL crosslinker was increased relative to the metal crosslinker.

Therefore, the present disclosure is well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
introducing a low-polymer loading treatment fluid (LPLTF) into a subterranean formation,
wherein the LPLTF comprises an aqueous-based fluid, a guar-based gelling agent in an amount of less than about 2.4 grams/liter of the liquid portion of the LPLTF, and a dual crosslinking additive comprising a metal crosslinker and a multifunctional boronic acid crosslinker in a ratio in the range of about 1:100 to about 100:1, and
wherein the LPLTF is thermally stable up to about 149° C.; and
performing a subterranean formation operation with the LPLTF at a target interval.

2. The method of claim 1, wherein the dual crosslinking additive is present in the range of about 0.001% to about 0.5% weight per volume of the liquid portion of the LPLTF.

3. The method of claim 1, wherein the metal crosslinker is selected from the group consisting of a magnesium ion, a zirconium IV ion, a titanium IV ion, an aluminum ion, an antimony ion, a chromium ion, an iron ion, a copper ion, a magnesium ion, a zinc ion, and any combination thereof.

4. The method of claim 1, wherein the metal crosslinker is a titanium-based crosslinker comprising titanium IV ions or a compound capable of supplying titanium IV ions, the compound selected from the group consisting of titanium lactate, titanium malate, titanium citrate, titanium ammonium lactate, titanium triethanol amine, and titanium acetylacetonate, titanium tetrachloride, titanium tetrabromide, titanium oxide, titanium nitrate, titanium sulfate, titanium carbonate, titanium cyanide, titanium acetate, titanium hydroxide, titanium chromate, titanium nitride, titanium hydochlorite, titanium phosphate, titanium dichromate, titanium nitrite, titanium borate, and any combination thereof.

5. The method of claim 1, wherein the multifunctional boronic acid crosslinker comprises a copolymer including at least one boronic acid monomer unit and at least one water-soluble monomer unit.

6. The method of claim 1, wherein the multifunctional boronic acid crosslinker comprises a copolymer including at least one boronic acid monomer unit and at least one water-soluble monomer unit, and wherein the at least one boronic acid monomer unit is selected from the group consisting of an aryl boronic acid, an alkyl boronic acid, an alkenyl boronic acid, an alkynyl boronic acid boronic acid, and any combination thereof.

7. The method of claim 1, wherein the multifunctional boronic acid crosslinker comprises a copolymer including at least one boronic acid monomer unit and at least one water-soluble monomer unit, and wherein the at least one water-soluble monomer unit is selected from the group consisting of an acrylamide, a 2-acrylamido-2-methyl propane sulfonic acid, a N,N-dimethylacrylamide, a vinyl pyrrolidone, a dimethylaminoethyl methacrylate, an acrylic acid, a dimethylaminopropylmethacrylamide, a vinyl amine, a vinyl acetate, a trimethylammoniumethyl methacrylate chloride, a methacrylamide, a hydroxyethyl acrylate, a vinyl sulfonic acid, a vinyl phosphonic acid, a vinylbenzene sulfonic acid, a methacrylic acid, a vinyl caprolactam, a N-vinylformamide, a diallyl amine, a N,N-diallylacetamide, a dimethyldiallyl ammonium halide, an itaconic acid, a styrene sulfonic acid, a methacrylamidoethyltrimethyl ammonium halide, a quaternary salt derivative of acrylamide, a quaternary salt derivative of acrylic acid, an alkyl acrylate, an alkyl methacrylate, an alkyl acrylamide, an alkyl methacrylamide, an alkyl dimethylammoniumethyl methacrylate halide, an alkyl dimethylammoniumpropyl methacrylamide halide, any derivative thereof, and any combination thereof.

8. The method of claim 1, wherein the LPLTF further comprises an additive selected from the group consisting of a surfactant, a buffering agent, a solid particulate, and any combination thereof.

9. The method of claim 1, wherein the subterranean formation has a cool-down temperature of less than about 149° C. at the target interval.

10. The method of claim 1, wherein the subterranean formation operation is selected from the group consisting of a fracturing operation, a frac-packing operation, a gravel packing operation, and any combination thereof.

11. A system comprising:
a tubular extending into a subterranean formation; and
a pump fluidly coupled to the tubular, the tubular containing a low-polymer loading treatment fluid (LPLTF) comprising an aqueous-based fluid, a guar-based gelling agent in an amount of less than about 2.4 grams/liter of the liquid portion of the LPLTF, and a dual crosslinking additive comprising a metal crosslinker and a multifunctional boronic acid crosslinker in a ratio in the range of about 1:100 to about 100:1,
wherein the LPLTF is thermally stable up to about 149° C.

12. The system of claim 11, wherein the guar-based gelling agent is present in an amount of about 0.6 grams/liter to about 2.4 grams/liter of the liquid portion of the LPLTF.

13. The system of claim 11, wherein the metal crosslinker is selected from the group consisting of a magnesium ion, a zirconium IV ion, a titanium IV ion, an aluminum ion, an antimony ion, a chromium ion, an iron ion, a copper ion, a magnesium ion, a zinc ion, and any combination thereof.

14. The system of claim 11, wherein the multifunctional boronic acid crosslinker comprises a copolymer including at least one boronic acid monomer unit and at least one water-soluble monomer unit.

15. The system of claim 11, wherein the LPLTF further comprises an additive selected from the group consisting of a surfactant, a buffering agent, a solid particulate, and any combination thereof.

16. A low-polymer loading treatment fluid (LPLTF) comprising:
an aqueous-based fluid;
a guar-based gelling agent in an amount of less than about 2.4 grams/liter of the liquid portion of the LPLTF; and
a dual crosslinking additive comprising a metal crosslinker and a multifunctional boronic acid crosslinker in a ratio in the range of about 1:100 to about 100:1,
wherein the LPLTF is thermally stable up to about 149° C.

17. The LPLTF of claim 16, wherein the dual crosslinking additive is present in the range of about 0.001% to about 0.5% weight per volume of the liquid portion of the LPLTF.

18. The LPLTF of claim 16, wherein the metal crosslinker is selected from the group consisting of a magnesium ion, a zirconium IV ion, a titanium IV ion, an aluminum ion, an antimony ion, a chromium ion, an iron ion, a copper ion, a magnesium ion, a zinc ion, and any combination thereof.

19. The LPLTF of claim 16, wherein the multifunctional boronic acid crosslinker comprises a copolymer including at least one boronic acid monomer unit and at least one water-soluble monomer unit.

20. The LPLTF of claim 16, wherein the LPLTF further comprises an additive selected from the group consisting of a surfactant, a buffering agent, a proppant, a solid particulate, and any combination thereof.
